(19) United States
(12) Patent Application Publication
(10) Pub. No.: US 2009/0048954 A1
(43) Pub. Date: Feb. 19, 2009

(54) Sub-accounting for an omnibus account

(75) Inventors: Jeremy J. Blackburn, Inver Grove Heights, MN (US); Vikram A. Kashyap, San Francisco, CA (US); Anthony T. Banas, Chicago, IL (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Canopy Financial

(21) Appl. No.: 11/891,719

(22) Filed: Aug. 13, 2007

(51) Int. Cl. G06Q 40/00

(52) U.S. Cl. 705/35

(57) ABSTRACT

Methods and apparatus, including computer program products, for sub-accounting for an omnibus account. A method includes, in a server, tracking summary balances of transactions for individual sub-accounts contained in an omnibus account according to transition type and transaction status.

### BACKGROUND

The present invention relates to data processing by digital computer, and more particularly to sub-accounting for an omnibus account.

The term omnibus refers to a single bank account, held at any eligible financial institution that several consumers contribute to. For example, a healthcare omnibus account refers to a single bank account held at any eligible financial institution that several consumers contribute healthcare-related deposits to. A consumer can direct funds in the healthcare omnibus account to pay for specific healthcare services, such as physician costs, laboratory costs, prescriptions and hospital costs, for example.

### SUMMARY

The present invention provides methods and apparatus, including computer program products, for sub-accounting for an omnibus account.

In general, in one aspect, the invention features a method including, in a server, tracking summary balances of transactions for individual sub-accounts contained in an omnibus account according to transition type and transaction status.

In embodiments, the transaction type can be selected from the group including consumer deposits to a healthcare-oriented banking account, employer deposits to a healthcare-oriented banking account, account reimbursements, bill payments, money transfers, investment trades, divestment trades, add additional account, profile updates and account closure and account liquidation.

The transaction status can be selected from the group including submitted transaction status, pending transaction status, processing transaction status, completed transaction status, failed transaction status and scheduled transaction status.

The transaction type and the transaction status can follow a set of business rules for how each transaction moves its way linearly through a life cycle. The set of business rules can be selected from the group including day of the week the transaction was submitted, day of the month the transaction was submitted, time of day the transaction was submitted, an individual submitting the transaction, type of transaction, contact channel the transaction was initiated from, length of time an account has been opened, current balance in an account and total value of all pending transactions against an account.

Each of the individual sub-accounts can be assigned a unique sub-accounting number. The unique sub-accounting number can include a sub-accounting identification, an employer identification number, a geographical identification number, a payer identification number, and a check number.

Tracking can include a fee income account used to collect all fees associated with any transaction type in real-time, an operating account used to hold all funds that can be pending or waiting to be processed for an outbound bill payment or reimbursement, and an audit account containing a shadow or net balance of all logical transactions from the individual sub-accounts each day.

In another aspect, the invention features a system including, in a network, a server including a processor, a memory including a sub-accounting process for tracking summary balances of transactions for individual sub-accounts contained in an omnibus account according to transition type and transaction status, and a storage device.

In embodiments, the transaction type can be selected from the group including consumer deposits to a healthcare-oriented banking account, employer deposits to a healthcare-oriented banking account, account reimbursements, bill payments, money transfers, investment trades, divestment trades, add additional account, profile updates and account closure and account liquidation.

The transaction status can be selected from the group including submitted transaction status, pending transaction status, processing transaction status, completed transaction status, failed transaction status and scheduled transaction status.

The transaction type and the transaction status can follow a set of business rules for how each transaction moves its way linearly through a life cycle. The set of business rules can be selected from the group inclusive of day of the week the transaction was submitted, day of the month the transaction was submitted, time of day the transaction was submitted, the individual submitting the transaction, type of transaction, contact channel the transaction was initiated from, length an account has been opened, current balance in an account and total value of all pending transactions against an account.

Each of the individual sub-accounts can be assigned a unique sub-accounting number. The unique sub-accounting number can include a sub-accounting identification, an employer identification number, a geographical identification number, a payer identification number, and a check number.

Tracking can include a fee income account used to collect all fees associated with any transaction type in real-time, an operating account used to hold all funds that can be pending or waiting to be processed for an outbound bill payment or reimbursement, and an audit account containing a shadow or net balance of all logical transactions from the individual sub-accounts each day.

The invention can be implemented to realize one or more of the following advantages.

A method is architected in a way that it can not only post interest returns to sub-accounts, but calculate investment gains and posts those gains to the sub-account as well.

A method uses a unique account numbering scheme that tracks deposits at the employer, insurance carrier, and geography levels.

A method's unique accounting structure automatically parses account fees from actual deposits.

A method generates a virtual matrix of healthcare banking transaction types and the status of those transactions to track the summary balances for each account.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary network.

FIG. 2 is a flow diagram of a sub-accounting process.

FIG. 3 is block diagram of an exemplary sub-accounting number.

FIG. 4 is block diagram of a sub-accounting logic.

FIG. 5 is an exemplary database snapshot.

Like reference numbers and designations in the various drawings indicate like elements.

### DETAILED DESCRIPTION

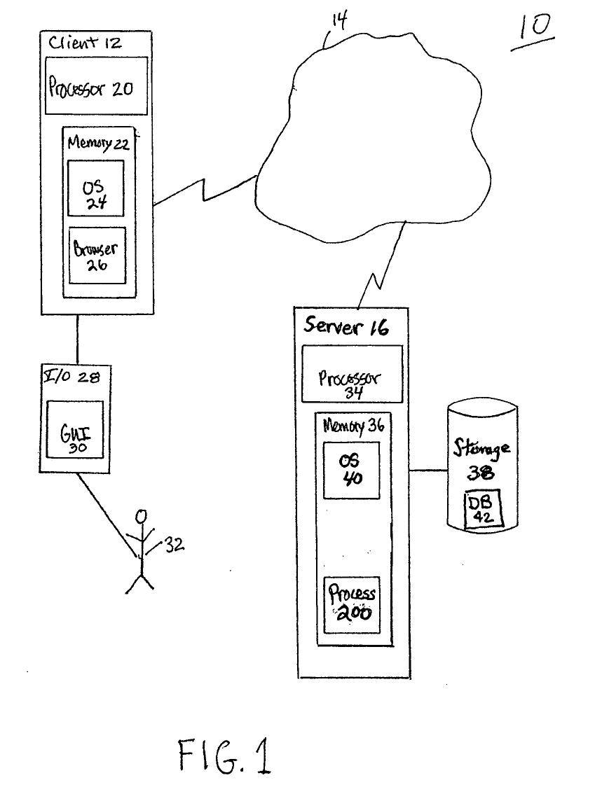

As shown in FIG. 1, an exemplary network 10, shown here as a client-server network, includes a client 12 connected to a global network of interconnected computers 14. In one particular example, the network 14 is the Internet. In other examples, the network 14 can be any network capable of transmitting data, such as, for example, an intranet, Local Area Network (LAN), Wide Area Network (WAN), or other network using point-to-point protocols (PPP), Wireless Application Protocols (WAP), and so forth. A server 16 is linked to the client 12 through the network 14.

The client 12 can include a processor 20 and memory 22. Memory 22 includes an operating system (OS) 24, such as Linux or Windows®, and a Web browser process 26. With Web browser 26, such as Firefox®, Opera®, or Netscape Navigator®, a user can view content on Web pages that may contain text, images, and/or other multimedia, and navigate between Web pages using hyperlinks.

The client 12 includes an input/output device 28 for display of a graphical user interface (GUI) 30, generated by Web browser process 16, for display to a user 32.

The server 16 can include a processor 34, memory 36 and storage device 38. Memory 36 includes an OS 40, such as Linux or Windows® and a sub-accounting process 200, described below. In one particular example, the sub-accounting process 200 enables the movement of those healthcare-related deposits from a consumer's bank account to an omnibus account held at a financial institution and then manages the balances associated with each consumer contribution to the omnibus account. The sub-accounting process 200 can be used with other types of omnibus accounts. Here, we use a healthcare example.

In a healthcare context, the sub-accounting process 200 functions by generating a virtual matrix of healthcare banking transaction types and the status of those transactions to track the summary balances for each account. This matrix of information can be stored in a database 42 maintained at the server 16 by the sub-accounting process 200.

The sub-accounting process 200 transparently manages electronic transactions that flow to or from a consumer, a consumer's bank account, and an omnibus healthcare account at a bank. In one particular example, the sub-accounting process 200 manages transactions for a consumer having accounts at more than a single bank or financial institution.

The sub-accounting process 200 tracks each transaction by type and status. Healthcare banking transaction types can include, for example, consumer deposits to a healthcare-oriented banking account, employer deposits to a healthcare-oriented banking account, account reimbursements, bill payments, money transfers, investment trades (i.e., buy), divestment trades (i.e., sell), add additional account, profile updates, account closure and account liquidation. Transaction statuses can include, for example, submitted, pending, processing, completed, failed and scheduled. Using transaction types and transactions statuses, the sub-accounting process 200 enables a financial institution to examine an omnibus account and evaluate, in real-time, trial balances for all “bill payment transactions” that are in a “pending” status.

Each one of the transaction types may come with its own set of unique behaviors in terms of how the sub-accounting process 200 treats interest accrual and what amounts of money a bank is willing to approve in debit card transactions. Each transaction type and transaction status follows a set of business rules for how each transaction moves its way linearly through a life cycle. These business rules can include, for example, day of the week the transaction was submitted, day of the month the transaction was submitted, time of day the transaction was submitted and the individual submitting the transaction. The business rules can include type of transaction (e.g., payment, reimbursement, and so forth), contact channel the transaction was initiated from, length the account has been opened, current balance in the account and total value of all pending transactions against the account.

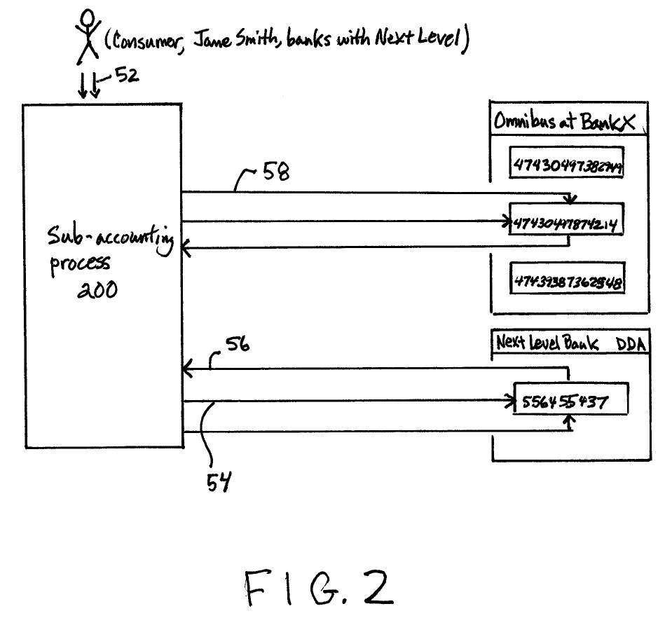

As shown in FIG. 2, a flow diagram 50 shows the sub-accounting process 200 receiving (52) a consumer request to deposit funds in an omnibus account. The sub-accounting process 200 requests (54) the consumer requested funds from the consumer's bank (e.g., NextLevel Bank), and receives (56) the requested funds from the bank. The received funds are posted (58) to the user's specific sub-accounting account.

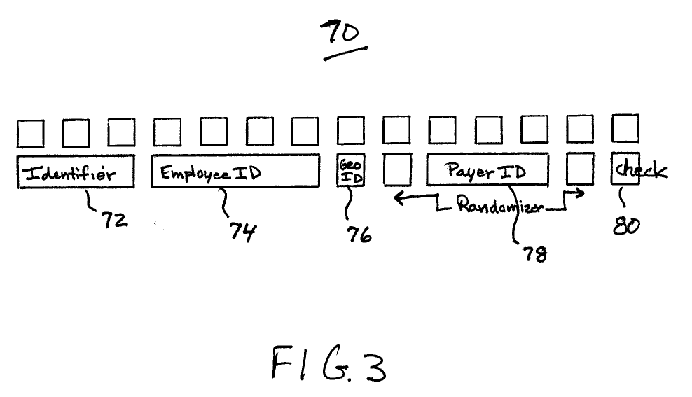

As shown in FIG. 3, each sub-accounting account is assigned a unique sub-accounting number 70. The sub-accounting number 70 can include, for example, a sub-accounting identification 72, an employer identification number 74, a geographical identification number 76, a payer identification number 78 and a check number 80. Using this sub-accounting number 70, each transaction is tracked by the sub-accounting process 200.

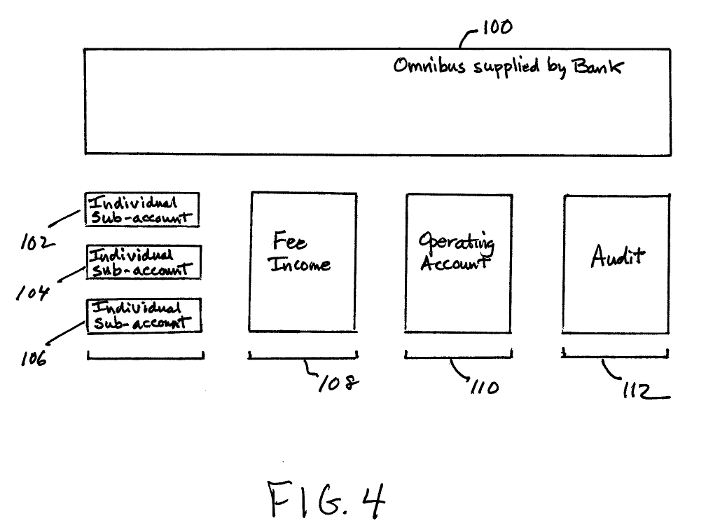

As shown in FIG. 4, a logical structure utilized by the sub-accounting process 200 includes an omnibus account 100, individual sub-accounts 102, 104, 106, a fee income account 108, an operating account 110 and an audit account 112. The omnibus account 100 is supplied by the bank.

Individual sub-accounts 102, 104, 106 are the unique identifiers generated by the sub-accounting process 200. In one particular example, as described above in FIG. 3, these sub-account identifications are fourteen digits in length and prefaced with “474” for individual accounts and “475” for employer accounts. Individual sub-accounts 102, 104, 106 are generated by the sub-accounting process 200 at the point of user/custodial agreement acceptance. Each sub-account 102, 104, 106 becomes the single-point-of-truth for balance management. All contributions, reimbursements, and interest payments (and calculations) are based on the available balance of the individual sub-accounts 102, 104, 106. In one example, the sub-accounting process 200 uses the average daily balance method for interest calculation and payment, which is a method of calculating interest by considering the balance owed or invested at the end of each day of the period rather than the balance owed or invested at the end of the week, month, or year.

The frequency of interest compounding affects how lenders and borrowers use the average daily balance method. If interest compounds monthly, then borrowers and lenders use the following formula to calculate interest under the average daily balance method:

(A/D)×(I/P)

Where:

A=the sum of the daily balances in the billing period

D=number of days in the billing period

I=annual interest rate

P=number of billing periods per year(usually 12)

If interest compounds daily, then lenders and borrowers calculate the interest on each day's ending balance and add this interest to the next day's beginning balance. The ending daily balances reflect the day's charges, payments, deposits, and withdrawals in both versions of this method.

All calculations are done by the sub-accounting process 200 and matched with interest payments made by the bank to the omnibus account.

The fee income account 108 is used to collect all fees associated with any transaction type in real-time. For example, if a user is charged a $25 setup fee at the time of enrollment and funds the account with $500 at the same time, two entries are generated by the sub-accounting process 200 to send the $25 of fee income directly into the fee income account 108. Sub-accounting process 200 also generates a general ledger entry for any incoming fee transaction to recognize the revenue associated with that fee. The fee income account 108 is typically swept at the end of each reporting period. Additionally, the fee income account 108 is used to reconcile billable or fee generating transactions at the end of each day to ensure that revenue generated matches transaction volume and transaction type.

The operating account 110 holds all funds that are “pending” or waiting to be processed for an outbound bill payment or reimbursement. The operating account 110 is non-interest bearing and is used to reconcile the number and value of all outbound contributions. The operating account 110 immediately reflects the value of a payment or reimbursement submitted between 3:01 PM Central to 2:59 PM Central, Monday through Friday. For scheduled or recurring transactions, the values of those outbound contributions are moved into the operating account 110 the day before the transaction is scheduled to clear. It is preferred that the operating account 110 be an overnight sweep account that can be accessed via an online interface for audit purposes.

The audit account 112 reflects the shadow or net balance of all logical transactions from the individual sub-accounts each day. This audit account 112 provides end of day balance matching on an individual account basis. It is preferred that the audit account 112 be an overnight sweep that can be accessed via an online interface for audit purposes. The balance in the audit account 112 is $0 by the end of each day and is a logical account used for generating daily audit files for the sub-accounting process 200.

Because the sub-accounting process 200 tracks each transaction by a status and a type, a bank can reconcile all of their accounts by a transaction status, i.e., transactions do not have a clear a bank to be reconciled. A bank can look at all debit requests by different transaction status. This enables the bank to do trial balances in real time rather than waiting for batch processing at the end of a day.

From an account management prospective, the sub-accounting process 200 can determine when an individual continues to accrue interest or when their investment starts and/or ends. In addition, the sub-accounting process 100 enables the bank to keep money in an account on behalf of an individual so the individual continues to accrue interest on those draft funds until the money is actually processed to a third party.

From a claims management/adjudication prospective, the sub-accounting process 200 ensures settlement of health care claims by tracking by the status of those claims in parallel with a status at the financial institution.

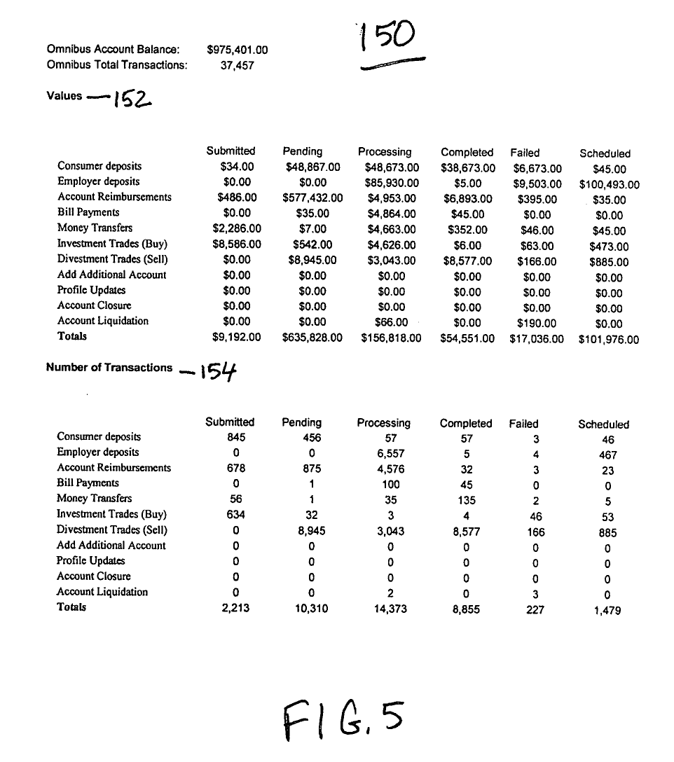

As shown in FIG. 5, an exemplary database snapshot 150 includes a listing of values 152 and number of transactions 154 tracked by transaction type and transaction status. In this example, the snapshot 150 indicates an omnibus account balance of $975,401.00 and 37,457 omnibus transactions. Using sub-accounting process 200, an institution can review that there are a total of 2,213 transactions in the “submitted” status, for a total of $9,192.00. More granularly, the same institution can see that there are 56 money transfer requests in the “submitted” status for a total of $2,286.00.

There are several workflow-related customizations that a financial institution can implement using the sub-accounting process 200. For example, a financial institution can customize the amount of time any transaction spends in any given status (e.g., a bank may require a deposit hold of 48 hours for all foreign health savings account contributions). The financial institution can customize general ledger posting times and frequency of postings for trial balance preparation, as well as aging of returned items and/or failed transactions.

The financial institution can customize originating depository financial institution processing windows, settlement account types, settlement processing times and frequency, and so forth.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
in a server, tracking summary balances of transactions for individual sub-accounts contained in an omnibus account according to transition type and transaction status.

2. The computer-implemented method of claim 1 wherein the transaction type is selected from the group consisting of consumer deposits to a healthcare-oriented banking account, employer deposits to a healthcare-oriented banking account, account reimbursements, bill payments, money transfers, investment trades, divestment trades, add additional account, profile updates and account closure and account liquidation.

3. The computer-implemented method of claim 1 wherein the transaction status is selected from the group consisting of submitted transaction status, pending transaction status, processing transaction status, completed transaction status, failed transaction status and scheduled transaction status.

4. The computer-implemented method of claim 1 wherein the transaction type and the transaction status follow a set of business rules for how each transaction moves its way linearly through a life cycle.

5. The computer-implemented method of claim 4 wherein the set of business rules is selected from the group consisting of day of the week the transaction was submitted, day of the month the transaction was submitted, time of day the transaction was submitted, an individual submitting the transaction, type of transaction, contact channel the transaction was initiated from, length an account has been opened, current balance in an account and total value of all pending transactions against an account.

6. The computer-implemented method of claim 1 wherein each of the individual sub-accounts is assigned a unique sub-accounting number.

7. The computer-implemented method of claim 6 wherein the unique sub-accounting number comprises:
a sub-accounting identification;
an employer identification number;
a geographical identification number;
a payer identification number; and
a check number.

8. The computer-implemented method of claim 1 wherein tracking comprises:
a fee income account used to collect all fees associated with any transaction type in real-time;
an operating account used to hold all funds that are pending or waiting to be processed for an outbound bill payment or reimbursement; and
an audit account containing a shadow or net balance of all logical transactions from the individual sub-accounts each day.

9. A system comprising:
in a network, a server comprising:
a processor;
a memory including a sub-accounting process for tracking summary balances of transactions for individual sub-accounts contained in an omnibus account according to transition type and transaction status; and
a storage device.

10. The system of claim 9 wherein the transaction type is selected from the group consisting of consumer deposits to a healthcare-oriented banking account, employer deposits to a healthcare-oriented banking account, account reimbursements, bill payments, money transfers, investment trades, divestment trades, add additional account, profile updates and account closure and account liquidation.

11. The system of claim 9 wherein the transaction status is selected from the group consisting of submitted transaction status, pending transaction status, processing transaction status, completed transaction status, failed transaction status and scheduled transaction status.

12. The system of claim 9 wherein the transaction type and the transaction status follow a set of business rules for how each transaction moves its way linearly through a life cycle.

13. The computer-implemented method of claim 12 wherein the set of business rules is selected from the group consisting of day of the week the transaction was submitted, day of the month the transaction was submitted, time of day the transaction was submitted, an individual submitting the transaction, type of transaction, contact channel the transaction was initiated from, length an account has been opened, current balance in an account and total value of all pending transactions against an account.

14. The system of claim 9 wherein each of the individual sub-accounts is assigned a unique sub-accounting number.

15. The system of claim 14 wherein the unique sub-accounting number comprises:
a sub-accounting identification;
an employer identification number;
a geographical identification number;
a payer identification number; and
a check number.

16. The system of claim 9 wherein tracking comprises:
a fee income account used to collect all fees associated with any transaction type in real-time;
an operating account used to hold all funds that are pending or waiting to be processed for an outbound bill payment or reimbursement; and
an audit account containing a shadow or net balance of all logical transactions from the individual sub-accounts each day.

17. A computer program product, tangibly embodied in an information carrier, for sub-accounting in an omnibus account, the computer program product being operable to cause data processing apparatus to:
in a server, track summary balances of transactions for individual sub-accounts contained in an omnibus account according to transition type and transaction status.

18. The computer program product of claim 17 wherein the transaction type is selected from the group consisting of consumer deposits to a healthcare-oriented banking account, employer deposits to a healthcare-oriented banking account, account reimbursements, bill payments, money transfers, investment trades, divestment trades, add additional account, profile updates and account closure and account liquidation.

19. The computer program product of claim 17 wherein the transaction status is selected from the group consisting of submitted transaction status, pending transaction status, processing transaction status, completed transaction status, failed transaction status and scheduled transaction status.

20. The computer-implemented method of claim 17 wherein the transaction type and the transaction status follow a set of business rules for how each transaction moves its way linearly through a life cycle.

21. The computer-implemented method of claim 20 wherein the set of business rules is selected from the group consisting of day of the week the transaction was submitted, day of the month the transaction was submitted, time of day the transaction was submitted, an individual submitting the transaction, type of transaction, contact channel the transaction was initiated from, length an account has been opened, current balance in an account and total value of all pending transactions against an account.

22. The computer program product of claim 17 wherein each of the individual sub-accounts is assigned a unique sub-accounting number.

23. The computer program product of claim 22 wherein the unique sub-accounting number comprises:
a sub-accounting identification;
an employer identification number;
a geographical identification number;
a payer identification number; and
a check number.

24. The computer program product of claim 17 wherein tracking comprises:
a fee income account used to collect all fees associated with any transaction type in real-time;
an operating account used to hold all funds that are pending or waiting to be processed for an outbound bill payment or reimbursement; and
an audit account containing a shadow or net balance of all logical transactions from the individual sub-accounts each day.
